(19) United States
(12) Patent Application Publication
(10) Pub. No.: US 2009/0302245 A1
(43) Pub. Date: Dec. 10, 2009

(54) FLUID CONTROL VALVE AND VALVE BODY

(76) Inventors: Kristian Lernmark, Stockholm (SE); Hans Sundqvist, Balsta (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/135,402

(22) Filed: Jun. 9, 2008

(51) Int. Cl. F16K 31/12

(52) U.S. Cl. 251/24

(57) ABSTRACT

A fluid control valve (10) comprising a valve housing (12), a valve body (30) having a peripheral surface (32) slidably supported for movement in an axial direction in the valve housing and a feedback circuit duct (38) in the valve body. The feedback circuit duct has a first end (40) communicating with a flow port (14) in the housing and a second end (42) opening at the peripheral surface (32). The second end is capable of exposing a variable opening area (A) to a control chamber (20) in the housing and thereby subjecting the valve body to said movement by a resulting difference between pressure dependent forces acting on opposite surfaces of the valve body. According to the invention, the second end comprises an aperture (42) having a peripheral width (w) that varies at least over a portion proximate to the control chamber of an axial length of the aperture exposable to the control chamber.

### TECHNICAL FIELD

The present invention relates to a fluid control valve comprising a valve housing and a valve body having a peripheral surface slidably supported for movement in an axial direction in the valve housing. A feedback circuit duct is provided in the valve body and has a first end and a second end. The first end communicates with a flow port in the housing and the second end opens at the peripheral surface of the valve body and is capable of exposing a variable opening area to a control chamber in the housing and thereby subjecting the valve body to said movement by a resulting difference between pressure dependant forces acting on opposite surfaces of the valve body. The invention also relates to a valve body for such a fluid control valve.

### BACKGROUND

A prior art valve of this type is the Valvistor® hydraulic feedback valve. The valve body of such valve is capable of amplifying a small pilot flow through the feedback duct that forms part of a pilot circuit. The second end of the feedback circuit duct comprises an axially extending constant-width slit through the peripheral surface of the valve body. In a prior art embodiment of a Valvistor® valve, the second end opening to the peripheral surface has shape of an inverted keyhole, i.e. a constant-width slit that has a downward widened portion of a circular shape. The circular widened portion does not, however, appear to participate in controlling the feedback flow, i.e. will not be exposed to the control chamber before the valve body engages a mechanical end stop in the valve housing, and is possibly a bore pre-drilled by manufacturing purposes to facilitate the subsequent shaping of the constant-width slit. If the widened end portion were exposed to the control chamber prior to end stop engagement it would possibly only have the function of retarding the valve body before said engagement, with no other specific control function.

The pilot flow may be controlled by a pilot valve in a manner that the valve body follows the movements of a pilot valve body in the pilot valve. In a basic configuration according to FIG. 1A of the accompanying drawing, the Valvistor® will usually have a proportional output to input characteristic as depicted by the full line 1A in the diagram of FIG. 2.

In many applications, however, for example when controlling heavy machinery such as excavator scoops with high precision by manual joy stick operation, it is desired to have a more progressive characteristic as depicted by the dotted line 1B in FIG. 2. This is made possible in a known manner by 1) modifying the poppet type valve to a combination of a poppet type and a spool type valve as shown in FIG. 1B, and 2) forming a saw-tooth pattern on the closing edge of the valve in order to control the flow initially very slowly in a progressive manner until the vertices of the saw-teeth leave the inlet opening in the valve housing. The jagged or saw-tooth edge of the valve body is, however, difficult to machine and therefore adds to the cost of the valve.

### DISCLOSURE OF THE INVENTION

An object of the invention is to provide a fluid control valve of the Valvistor® type that can be implemented with a desired characteristic in a simplified manner.

This is obtained by the features of the appended claims.

In an aspect of the invention, the second end of the feedback circuit duct comprises an aperture having a peripheral width that varies at least over a portion proximate to the control chamber of an axial length of the aperture exposable to the control chamber. Thereby, the characteristic of the valve body can be governed by small, low cost measures of the metering aperture of the feedback duct. More precisely, the constant-width slit of the prior art that exposes the variable opening area to the control chamber may easily be replaced by an aperture formed to any shape that varies in the opening direction, for example by electro discharge machining. In the context of the following description and appended claims, the portion proximate to the control chamber may well be understood as to extend at least over the half of the axial length of the aperture exposable to the control chamber.

Specifically, the aperture width may start varying from an aperture end proximate to the control chamber.

In one embodiment of the invention, the width of the opening area is decreasing in an axial direction of the valve body opening the valve. In that case the valve will be capable of having, for example, a progressive output flow to input signal characteristic. For example, if the aperture is shaped as a triangle having an apex pointing away from the opening direction of the valve body, the characteristic will follow approximately a quadratic curvature, initially presenting a very small derivative, which may be of importance when controlling high loads with high precision. Generally, widening the aperture will decrease the derivative of the characteristic and vice versa.

In another embodiment, the width of the opening area is increasing in the axial direction of the valve body opening the valve, for example by using a triangular aperture where an apex is pointing in the opening direction of the valve body. This will give a regressive characteristic that may be useful in certain applications.

In applications with no specific requirements to desired output to input characteristics, the single aperture can have a circular shape. The aperture may then be formed by a low cost drilling operation.

In still another embodiment, the second end of the feedback circuit is composed of a plurality of apertures. In that case, the apertures can also be formed by drilling circular bores from the peripheral surface of the valve body into the adjoining remainder of the feedback duct of the valve body. The apertures may then also overlap each other in the axial direction.

The apertures can also be mutually spaced around the peripheral surface. This may have a balancing influence on the valve body from fluid pressure forces in the apertures.

Other features of the invention may be evident from the following detailed description and the claims.

### BRIEF DESCRIPTION OF THE DRAWING

FIGS. 1A and 1B are diagrammatic sectional views with parts broken away of known embodiments of valves of the Valvistor® hydraulic feedback type;

FIG. 2 is a graph showing typical characteristics of the respective valves shown in FIGS. 1A and B;

FIG. 3 is a broken away view, partly in section, of a valve according to the invention;

FIG. 4 is a view corresponding to FIG. 3 of a modified valve according to the invention;

FIGS. 5 and 6 are side views from above and below of respective valve bodies according to the invention;

FIGS. 7 through 13 are broken away views showing different configurations of valve body feedback apertures; and

FIG. 14 is a spread-out view of a peripheral surface of a valve body having peripherally distributed feedback apertures according to the invention.

In the different embodiments of valves shown on the drawing, elements with similar functions are throughout designated by the same reference numerals.

### DETAILED DESCRIPTION OF EMBODIMENTS

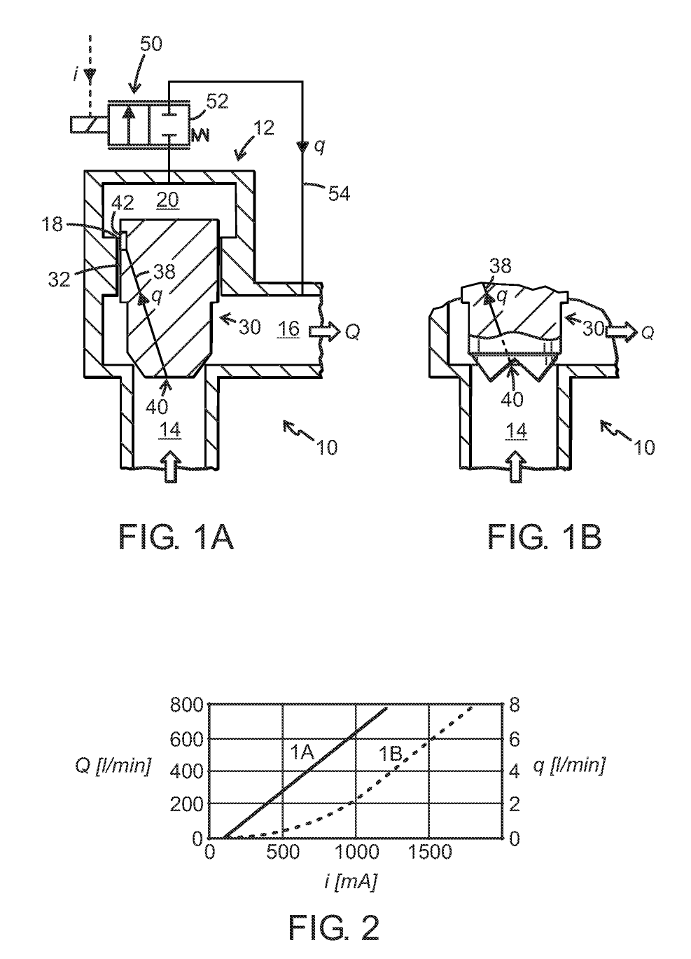

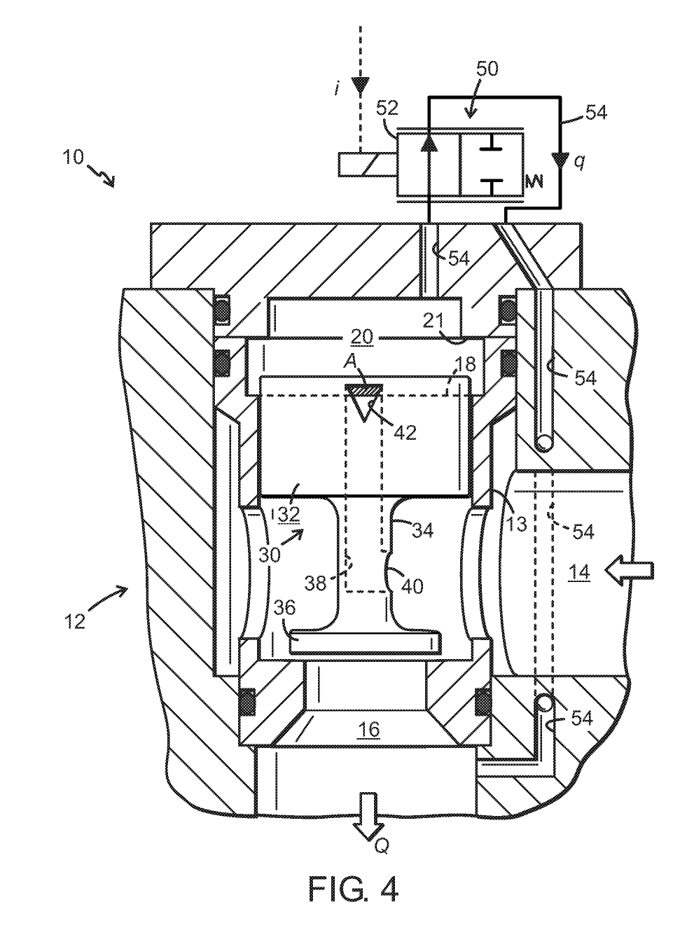

The fluid control valves 10 shown on the drawing are typically hydraulic power control valves comprising a valve housing 12 and a valve body 30 slidably received in the valve housing 12 for controlling a main flow Q of a pressurized fluid between an inlet port 14 and an outlet port 16 defined in the valve housing 12. The flow closing and opening end of the valve body 30 may optionally and independent of the invention be of different types: In the prior art embodiment of FIG. 1A, the valve body 30 is of a poppet seat valve type having a frusto-conical closing end. In the prior art embodiment of FIG. 1B, the valve body 30 is of a combined poppet and spool type having a serrated or saw-tooth shaped closing end as mentioned in the foregoing. In the exemplary embodiment of FIGS. 3-6 according to the invention the valve body 30 is of the seat valve type, having a disc-shaped closing member 36. Accordingly, embodiments of the valve body of the invention may have any suitable type of closing end for the main flow.

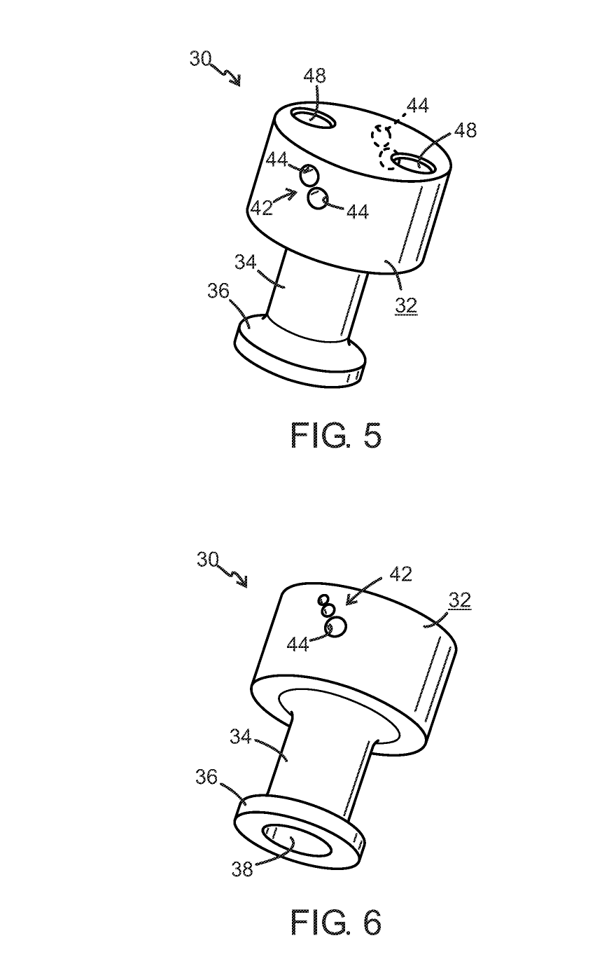

The valves are further of the Valvistor® hydraulic feedback type. In the exemplary embodiments of this type of valve, modified according to the invention and shown on FIGS. 3 and 4, a small flow q of a feedback control circuit may be controlled by a pilot valve such as the pilot valve 50 shown on FIGS. 1A and 3.

The feedback control circuit extends as follows from the inlet port 14:

1) into a feedback duct 38 in a first end 40 of the valve body 30;

2) out of a second end of the feedback duct 38, forming an aperture 42 in a peripheral surface 32 of the valve body 30, wherein the aperture 42 has a variable opening area A (FIGS. 3, 4 and 7) presented above a metering edge 18 defined in a control chamber 20 of the valve housing 12;

3) into the control chamber 20;

4) from the control chamber 20 and into the pilot valve 50;

5) out of the pilot valve 50 and into the outlet port 16 via a line 54 extending from the pilot valve 50.

In the reversed-flow embodiment of FIG. 4 according to the invention, the inlet and outlet ports 14, 16 are interchanged. The line 54 of the feedback control circuit will then open into the port 16 that is now located axially below the valve body 30. In this case, the first end 40 of the valve body 30 opens at the valve stem 34 into inlet port 14.

As indicated in FIGS. 3 and 4, the valve stem 34 can have a relatively small diameter for allowing the bottom face of the disc-shaped closing member 36 to resiliently adapt to the opposite face of the valve housing 12 in the valve closing position. Thereby the closing faces need not be machined to perfect parallelism.

In the embodiments of FIGS. 3 and 4 the valve body 30 is also in a known manner received in a separate element 13 forming part of the valve housing 12 and in turn received in a main valve block of the valve housing 12.

The operation of the valve 10 according to the embodiment shown on FIG. 3 is approximately as follows:

Initially, the valve body 30 closes the passage between the inlet and outlet ports 14, 16. The pressure in the outlet port 14 is communicated to the control chamber 20 via the feedback duct 38 and a small opening area A exposed over the metering edge 18. As the cross sectional area of the valve body 30 presented to the pressure is larger in the control chamber 20 than in the inlet port, and the pressure acting on the remaining cross sectional area presented in the outlet port 16 of the valve body 30 is comparatively low, the valve body 30 remains seated in the closed state.

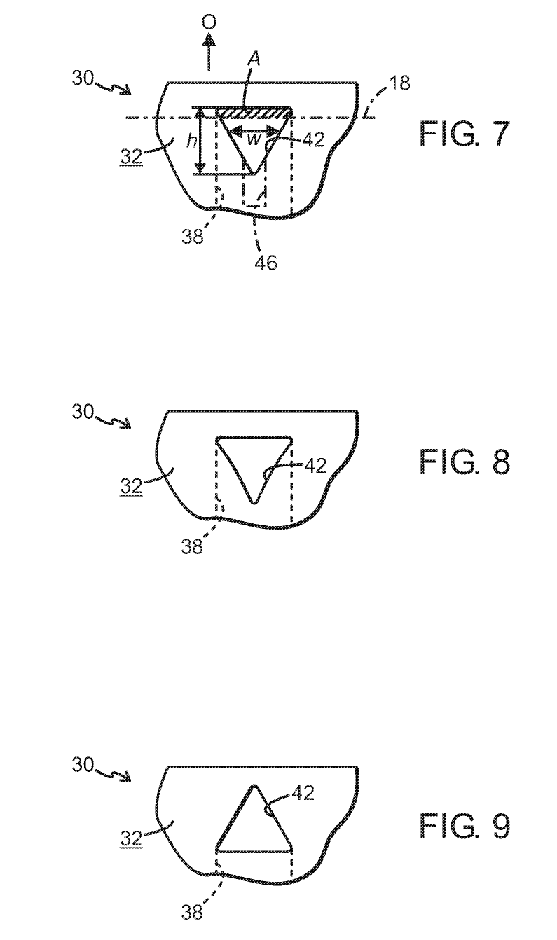

If needed, however, embodiments of the invention can be provided with one or more springs (not shown) such as helical compression springs in the control chamber 20 to assist movement of the valve body 30 in the closing direction. Recesses 48 (FIG. 5) may then be provided in the valve body 30 to accommodate such springs.

To open the valve 10, an input signal i, for example an electric current, moves a valve spool 52 via a solenoid in the pilot valve 50 from the closed position as shown in FIG. 1 to the right, into a gradually opened position. To this end, it is also possible to use an inverted pilot valve, i.e. a pilot valve that is normally open and closes gradually when influenced by the input signal (not shown).

The control chamber 20 is thereby opened to the outlet port 16 that has a lower pressure than that in the inlet port 14. The pressure in the control chamber 20 then decreases resulting in the valve body 30 moving upwards into the control chamber 20 and opening the inlet port 14 to the outlet port 16. The pressure in the control chamber 20 will then adjust to a level between the pressures in inlet 14 and outlet 16, resulting in the valve body 30 being balanced by equal opposite forces. By appropriate design of the valve 10, including the aperture 42, the valve body 30 will thereby be capable of remaining in the degree of opening determined by the degree of opening of the pilot valve 50.

If the pilot valve is further opened, the pressure again decreases in the control chamber 20 resulting in the valve body 30 moving further into the control chamber 20. The aperture 42 will now present a larger opening area A that is capable of equalizing the forces acting at the opposite cross sections of the valve body 30 at a higher rate of the small feedback control flow q, resulting in that the valve body remains in its new position further into the control chamber 20.

The operation described above is reversible so that the valve body 30 will invariably follow the movements of the pilot valve spool 52 in a master-slave manner.

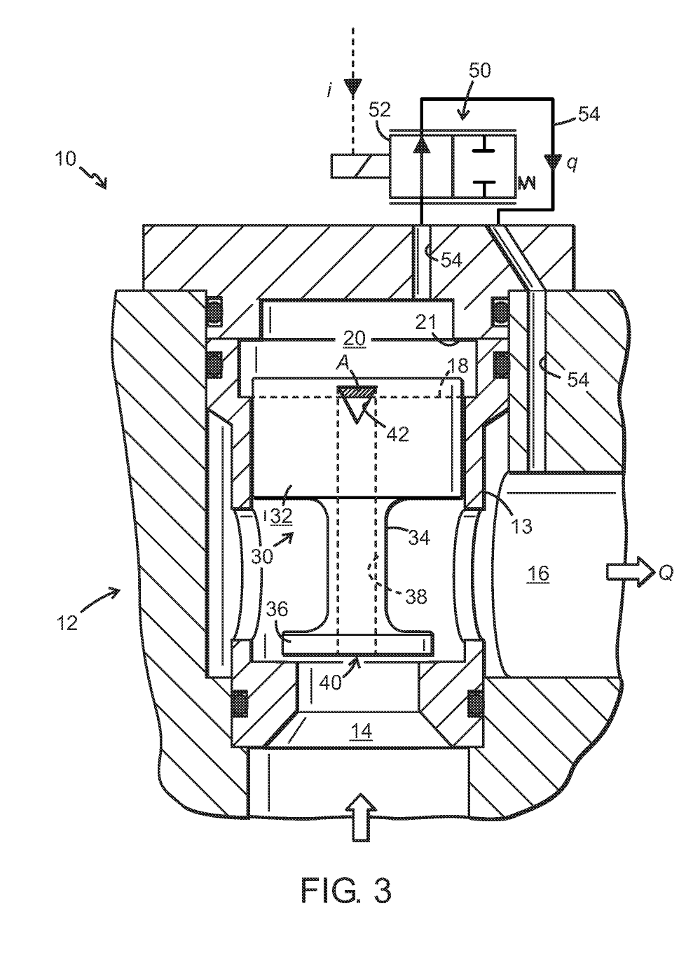

As already mentioned in the foregoing, a basic embodiment of the prior art Valvistor® valve, as exemplified in FIG. 1A, is capable of performing a proportional input to output characteristic shown by line 1A in FIG. 2. This is because the slit 42 in this case by definition has a constant peripheral width, presenting an area over the metering edge 18 that varies proportionally to the movement of the valve body 30. A prior art modified embodiment of the Valvistor® valve, as exemplified in FIG. 1B, is capable of performing a progressive output to input characteristic shown by curved line 1B in FIG. 2; only, however, by modifying the main flow controlling end of the valve body 30.

In the embodiments according to the invention shown on FIGS. 3-12, the characteristic of the valve can be modified by giving the feedback aperture 42 of the valve body 30 a peripheral width w that varies in a desired manner in an axial direction of the valve body 30.

Thereby the opening area A—as well as the resulting valve characteristic—presented over the metering edge 18, does not vary in the proportional linear manner in response to the movement of the valve body 30. For example, if the aperture 42 has the shape of a triangle having a base closest to the control chamber 20 and parallel to the metering edge, as shown in FIGS. 3, 4, and 7, the opening area A will not increase proportionally to the opening movement of the valve body 30 but in a progressive manner corresponding to a square function as shown by the curved initial section of characteristic line 1B of FIG. 2.

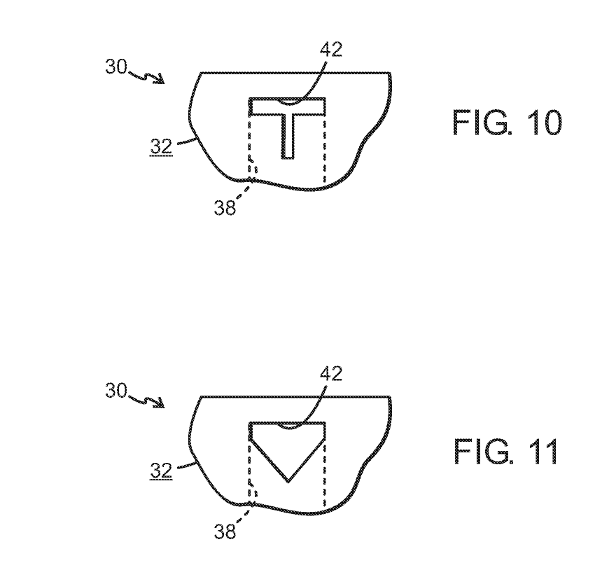

The height or exposable length h (FIG. 7) of the aperture 42 will determine the attainable movement or opening degree of the valve body 30. The movement may also be delimited by a surface 21 opposing the valve body 30 in the valve housing 12. In a manner not shown, this surface may alternatively be defined by the top end of the control chamber 20. The aperture 42 may, however, for example by manufacturing purposes, also have an inoperative remaining, lower or bottom portion that is never exposed to the control chamber 20 and therefore may have any size or shape. In a modified embodiment of the valve shown in FIG. 4 the remaining lower portion of the aperture 42 may be formed as a slit (not shown) extending axially along the peripheral surface 32 and into communication with port 14 to thereby replace duct 38.

The rate of progress of the valve characteristic curve may possibly be varied by varying the width to height ratio of the aperture. Specifically, by varying the apex angle of the triangle, a larger apex angle, for example, will extend the characteristic curve in the horizontal direction.

If the triangular aperture 42 is defined by convex opposite sides, as illustrated in FIG. 8, the characteristic curve will be somewhat extended in the vertical direction as compared to the characteristic curve of a corresponding triangular aperture having linear opposite sides.

If the triangular aperture 42 is reversed, as illustrated in FIG. 9, the characteristic curve will have a regressive characteristic, initially exhibiting a steep output to input valve characteristic curve.

Further, the width need not necessarily vary over the full height of the aperture: As indicated in phantom on FIG. 7, a lower section 46 of the aperture 42 may alternatively still have a constant width in the different embodiments and may also extend downwards beyond the attainable height h as discussed above. The variation of width, however, is always present at an initial or control portion of an axial length of the aperture 42 exposable to the control chamber 20.

In the embodiment of FIG. 10 the aperture 42 has a constant width that varies stepwise in the axial direction, and in the embodiment of FIG. 11 the aperture has a beginning short constant width and a following and ending linearly decreasing width. In these examples valve can have two modes: 1) An initial, flat characteristic, fine-tunable mode and 2) a remaining, steep characteristic mode responding fast to pilot valve operation.

In applications with no specific demands on output to input characteristic, the single aperture 42 can alternatively have a circular shape as shown on FIG. 12. The aperture may then be formed by a low cost drilling operation.

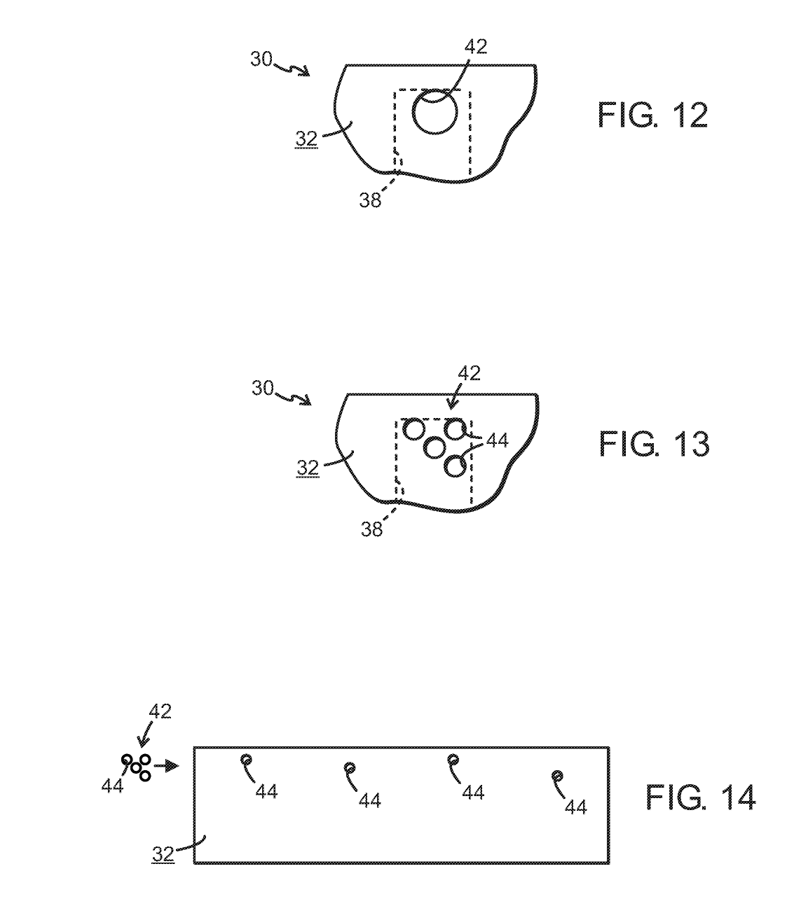

As illustrated in FIGS. 5, 6, 13 and 14, the feedback channel 38 can also have a plurality 42 of apertures 44 spaced in a manner over the peripheral surface for obtaining a desired valve characteristic. The apertures 44 can but need not necessarily be circular bores obtained, for example, by drilling. The apertures 44 may also overlap each other in the axial direction of the valve body 30. If the apertures 44 are evenly distributed over the periphery, as indicated in FIG. 14, they may assist in centering the valve body 30 in the supporting housing by balancing the radial offset forces resulting from fluid pressure in the apertures 44.

The foregoing detailed description is given primarily for clearness of understanding and no unnecessary limitations are to be understood therefrom. Modifications will become obvious to those skilled in the art upon reading this disclosure and may be made without departing from the spirit of the invention or the scope of the appended claims.

1. A fluid control valve comprising:
a valve housing;
a valve body having a peripheral surface slidably supported for movement in an axial direction in the valve housing;
a feedback circuit duct in the valve body;
said feedback circuit duct having a first end and a second end;
said first end communicating with a flow port in the housing;
said second end opening at said peripheral surface and capable of exposing a variable opening area to a control chamber in the housing and thereby subjecting the valve body to said movement by a resulting difference between pressure dependant forces acting on opposite surfaces of the valve body;
wherein said second end comprises an aperture having a peripheral width that varies at least over a portion proximate to the control chamber of an axial length of the aperture exposable to the control chamber.

2. The valve according to claim 1, wherein said width starts varying from an aperture end proximate to said control chamber.

3. The valve according to claim 1, wherein said width is decreasing in an axial direction opening the valve.

4. The valve according to claim 3, wherein said aperture has a triangular shape.

5. The valve according to claim 1, wherein said width is increasing in an axial direction opening the valve.

6. The valve according to claim 5, wherein said aperture has a triangular shape.

7. The valve according to claim 1, wherein said aperture has a circular shape.

8. The valve according to claim 1, wherein said second end is composed of a plurality of apertures.

9. The valve according to claim 8, wherein said apertures are circular apertures.

10. The valve according to claim 8, wherein said apertures are overlapping in said axial direction.

11. The valve according to claim 8, wherein said apertures are mutually spaced around said peripheral surface.

12. The valve according to claim 1, wherein said width varies in a stepwise manner.

13. A valve body comprising:
a peripheral surface to be slidably supported for movement in an axial direction in a valve housing;
a feedback circuit duct in the valve body;
said feedback circuit duct having a first end and a second end;
said first end being capable of communicating with a flow port in the housing;
said second end opening at said peripheral surface and capable of exposing a variable opening area to a control chamber in the housing and thereby subjecting the valve body to said movement by a resulting difference between pressure dependent forces acting on opposite surfaces of the valve body;
wherein said second end comprises an aperture having a peripheral width that varies at least over a portion proximate to the control chamber of an axial length of the aperture exposable to the control chamber.

14. The valve according to claim 13, wherein said width starts varying from an aperture end to be located proximate to said control chamber.

15. The valve body according to claim 13, wherein said width is decreasing in an axial direction opening the valve.

16. The valve body according to claim 15, wherein said aperture has a triangular shape.

17. The valve body according to claim 13, wherein said width is increasing in an axial direction opening the valve.

18. The valve body according to claim 17, wherein said aperture has a triangular shape.

19. The valve body according to claim 13, wherein said second end is composed of a plurality of apertures.

20. The valve body according to claim 19, wherein said apertures are circular apertures.

21. The valve body according to claim 19, wherein said apertures are overlapping in said axial direction.

22. The valve body according to claim 19, wherein said apertures are mutually spaced around said peripheral surface.

23. The valve according to claim 13, wherein said width varies in a stepwise manner.
